(19) United States
(12) Patent Application Publication
(10) Pub. No.: US 2006/0152643 A1
(43) Pub. Date: Jul. 13, 2006

(54) Liquid crystal display device

(75) Inventors: Ya-Min Liang, Padeh City (TW); Hui-Chung Shen, Padeh City (TW)

Correspondence Address: LOWE HAUPTMAN BERNER, LLP, 1700 DIAGONAL ROAD, SUITE 300, ALEXANDRIA, VA, 22314, US

(73) Assignee: CHUNGHWA PICTURE TUBES, LTD., Padeh City (TW)

(21) Appl. No.: 11/288,088

(22) Filed: Nov. 29, 2005

(30) Foreign Application Priority Data
Jan. 7, 2005 (TW) 94122473

(51) Int. Cl. G02F 1/1333

(52) U.S. Cl. 349/40

(57) ABSTRACT

The liquid crystal display (LCD) device comprises a terminal, an electrostatic discharge unit, and a metal line electrically connected with the terminal and the electrostatic discharge unit. The characteristic of the device is that the metal line extends along a first direction and the metal line includes a first portion and a second portion connecting with the first portion. The first and second portions have different line widths. The first portion provides position during the rim grinding process that reduces signal interference caused by connection bias to the neighbouring line after IC-mounting and the short-circuit problem; Furthermore, it improves the quality of LCD.

### CROSS-REFERENCE TO RELATED APPLICATIONS

This non-provisional application claims priority under 35 U.S.C. § 119(a) on Patent Application No. 094122473 filed in Taiwan, R.O.C. on Jul. 1, 2005, the entire contents of which are hereby incorporated by reference.

### BACKGROUND OF THE INVENTION

1. Field of the Invention

The invention generally relates to a liquid crystal display device, and in particular relates to a liquid crystal display device having a pattern design for position-recognition.

2. Description of Related Art

The manufacturing process of a liquid crystal display is first to form an array substrate and a color filter substrate. The thin film transistor (TFT) array on the array substrate is made through semiconductor manufacturing processes, such as the film deposition, the photolithography and the etching. After the array substrate and color filter substrate are finished, the substrates are successively bonded and cut. FIG. 1A is a structure of a conventional liquid crystal display. The liquid crystal display (LCD) includes an array substrate 10 and a color filter substrate 11. The array substrate 10 has an area larger than that of the color filter substrate 11. The portion of the array substrate 10, not overlap with the color filter substrate 11, is the area of terminals. The scanning lines are located on the shorter side, and the data lines are located on the longer side. The scanning lines have terminals connected to the gates of the thin film transistors of the array substrate 10. The data lines have terminals connected to the source of thin film transistors of the array substrate 10.

In the above manufacturing process of liquid crystal display, electrostatic discharge (ESD) is an important process. The reason is that the glass substrate of the liquid crystal display is an electrically insulating material. When electrostatic charges exist on the glass surface, the decay rate is quite slow. Therefore, during the manufacturing process, the scanning lines and the data lines are respectively formed with electrostatic discharge units, such as short bars or short rings, so as to prevent from electrostatic destruction. This electrostatic discharge units are removed when the liquid crystal display being ground of its rim and sides.

Please refer to FIG. 1B, a partial view of terminals of a conventional liquid crystal display. There are two scanning line terminals 12, 13; two connection lines 14, 15 and one short ring 16 showing. The connection lines 14, 15 have one end connected to the scanning line terminals 12, 13, and another end connected to the short ring 16 respectively. The connection lines 14, 15 are formed with N-shape so that during the grinding process, the central point of the N portion is recognized as a margin to remove the short ring 16 and halves of the connection lines. Please refer to FIG. 1C, a partial view of terminals of a liquid crystal display after being ground. Halves of the connection lines 14, 15 and short ring 16 have already been removed.

Please refer to FIG. 1D, a partial view of terminals of a conventional liquid crystal display after a process of mounting a driving integrate circuit (IC). The driving IC 17 is linked via a connection line 18. The driving IC 17 is supplied from a tape carrier package and linked via the connection line 18 to the scanning line terminal 13. However, because of manufacturing deviation, the connection line 18 is biased to touch the neighbouring connection line 14. The displacement bias will cause signal interference or even short-circuit of the neighbouring connection line 14. The reason why the connection line 18 easily contacts the connection line 14 is that the N-shaped connection line 14 leaves a tail 19 after the grinding, and the connection line 14 does not align with the center line of the scanning line terminal 12.

Whether the liquid crystal display has the displacement bias that causes signal interference or even short-circuit to the neighbour line is the key point of manufacturing quality. Therefore, how to solve the above problem is an important issue.

### SUMMARY OF THE INVENTION

The object of present invention is to overcome the aforesaid problem of signal interference or short-circuit for neighbouring lines caused by the displacement bias of manufacturing deviation due to the N-shaped connection line for improving the quality of LCD panel.

In order to achieve the object, this invention provides an LCD comprising a terminal, an electrostatic discharge unit, a metal line electrically connected with the terminal and the electrostatic discharge unit. The characteristic of the invention is that the metal line extends along a first direction. The metal line comprises a first portion and a second portion connecting with the first portion. The first and second portions have different line widths. The first portion is used for position during the grinding process of the LCD.

The liquid crystal display device of the invention having at least one pattern on one-side or two-side of the metal line to substitute conventional N-shape structure that provides position during the rim grinding process. The first portion provides position during the rim grinding process that reduces signal interference caused by connection bias to the neighbouring line after IC-mounting and the short-circuit problem; Furthermore, it improves the quality of LCD.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1A is a constructional view of a conventional liquid crystal display;

FIG. 1B is a partial constructional view of terminals of a conventional liquid crystal display;

FIG. 1C is partial constructional view of terminals of a conventional liquid crystal display after a rim grinding process;

FIG. 1D is partial constructional view of terminals of a conventional liquid crystal display after mounting a driving IC;

FIG. 2 is a partial constructional view of scanning line terminals of a liquid crystal display of the present invention;

FIG. 3 is a partial constructional view of terminals of a liquid crystal display of the present invention after rim grinding process and mounting a driving IC; and

FIG. 4A, FIG. 4B, FIG. 4C, FIG. 4D, FIG. 4E and FIG. 4F are serial constructional views of connection lines in other embodiments of the present invention.

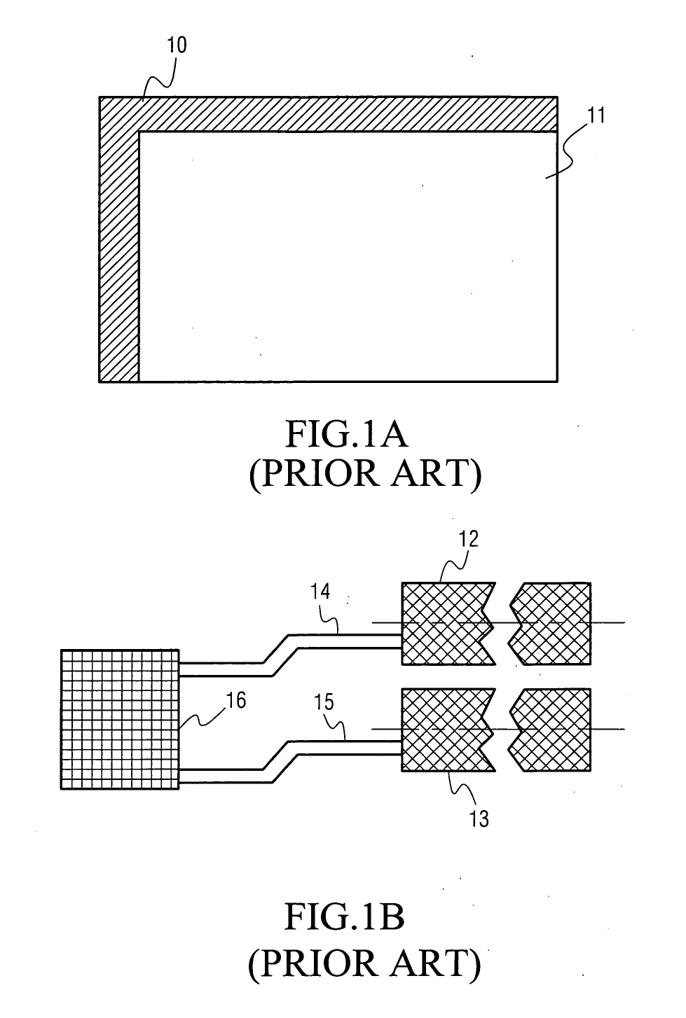

### DETAILED DESCRIPTION OF THE INVENTION

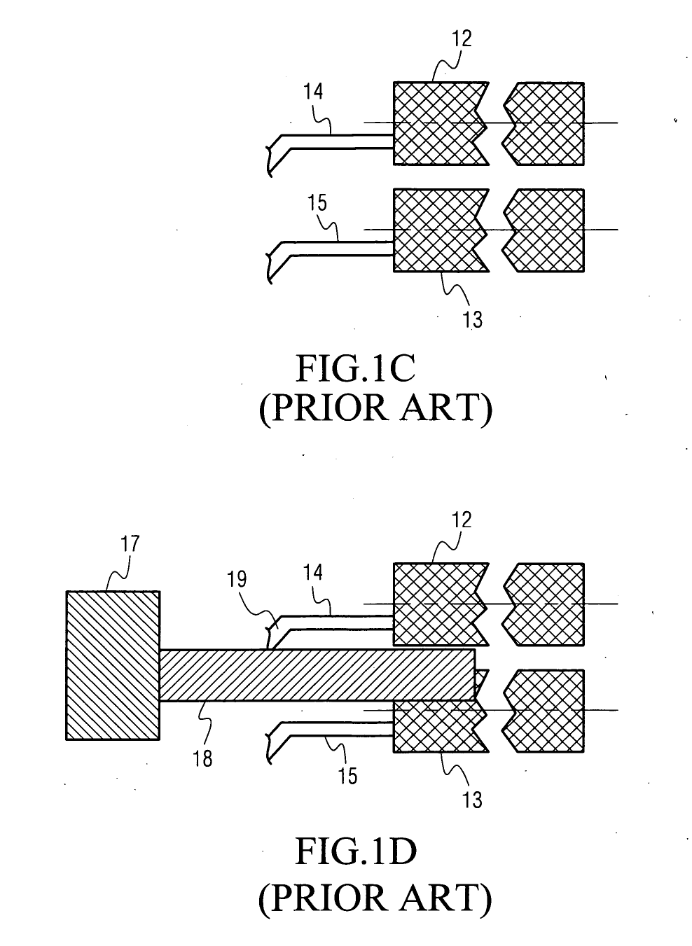

Please refer to FIG. 2, a partial constructional view of scanning line terminals in a liquid crystal display device of the present invention comprising scanning line terminals 21, 22, metal lines 23, 24, and an electrostatic discharge unit 27. One end of the metal line 23 links to the central portion of the scan line terminal 21; and another end links to the electrostatic discharge unit 27. The metal line 23 can be formed during the stage of making the gate of the thin film transistor through process of thin film deposition, photolithography and etching. By linking the gate of the thin film transistor to the electrostatic discharge unit 27 by the metal line 23, the electrostatic charges accumulating on the glass substrate of the liquid crystal display can be eliminated and prevented from destructing the thin film transistor. The metal lines 23, 24 are formed with first portions 25, 26. The shape of first portion 25, 26 can be a trapezoid and the first portions 25, 26 can be located on any point of the first metal lines 23, 24 but not touching the scan line terminals 21, 22. The first portion is for position-recognition during the rim grinding process. In other words, in the rim grinding process, the central points of the first portion portions are taken as margins to remove the electrostatic discharge unit 27 and halves of the metal lines 23, 24.

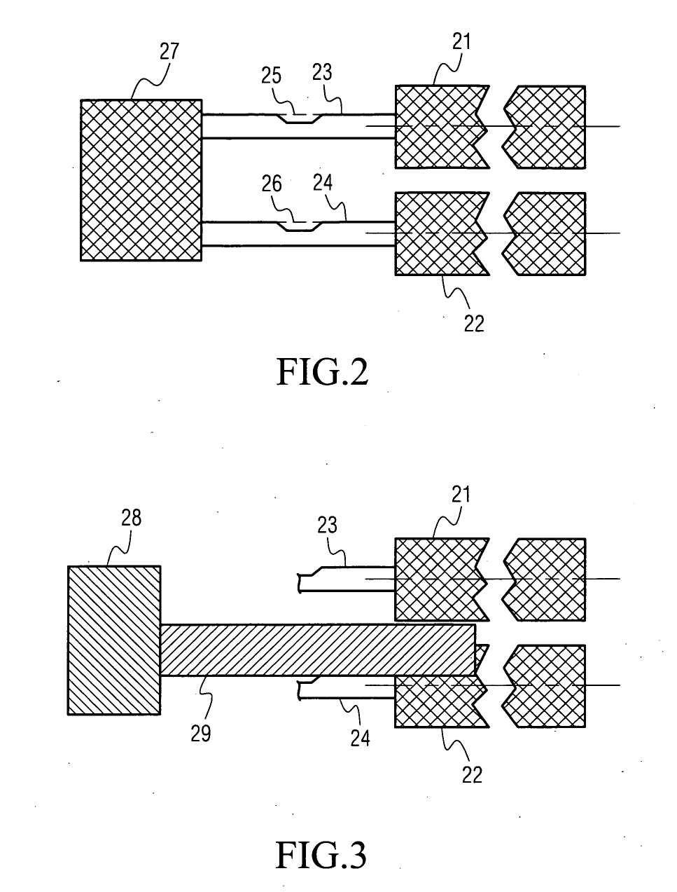

FIG. 3 shows a partial constructional view of terminals of a liquid crystal display of the present invention after rim grinding process and mounting a driving IC. Halves of the metal line 23 and the metal line 24 and short-rings connecting to them have been removed. The grinding process may apply a diamond grinder to grind the rim of the glass substrate. The grinding also smoothes the sides of the glass substrate and avoids the glass substrate giving fragments in further processes.

A metal line 29 connects to the driving IC 28. Then attach the metal line 29 to the scanning line terminal 22. The driving IC 28 then electrically connects to the gates of the thin film transistors via the scanning lines. However, since the metal line 23 does not have the N-shape portion, and one end of the metal line 23 connects to the central line of the scanning line terminal 21. Therefore, the metal line 29 is not easy to contact the neighbouring metal line 23 or cause signal interference or even short-circuit problem.

In other embodiments of the invention, the metal line has a first portion and a second portion connecting with the first portion. The first and second portions have different line width. The shape of first portion can be an arc, a triangle, a trapezoid, a rectangle, or a polygon, etc and the first portion can be a protrusion or a recession.

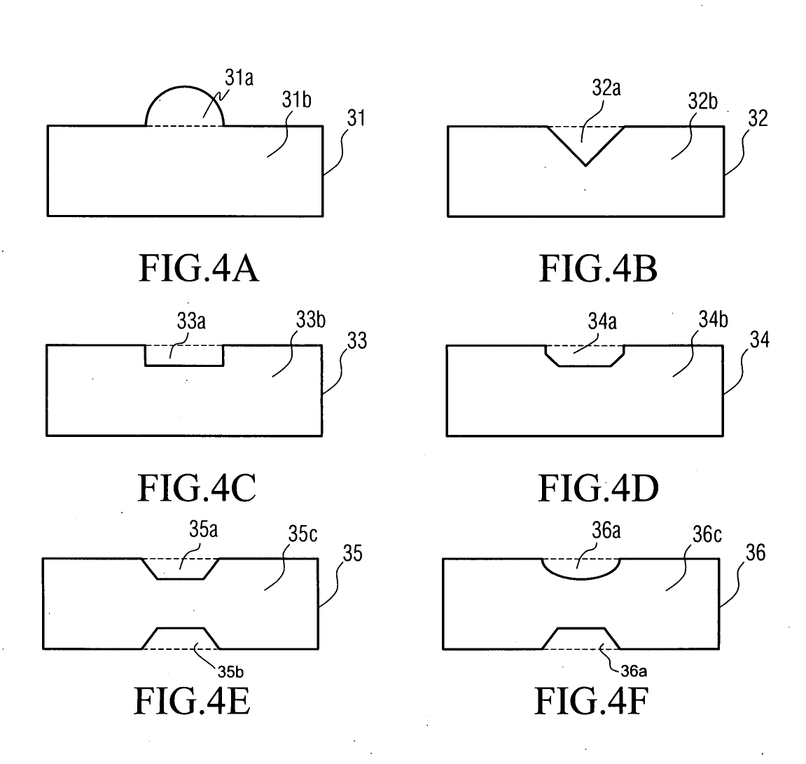

FIG. 4A is one of serial constructional views of metal line. The metal line 31 has a first portion 31a on one side and the first portion 31a is a protrusion. The first portion 31a and a second portion 31b connecting with the first portion 31a are differed in line width and the first portion 31a is an arc.

FIG. 4B is another serial constructional view of metal line. The metal line 32 has a first portion 32a on one side and the first portion 32a is a recession. The first portion 32a and a second portion 32b connecting with the first portion 32a are differed in line width and the first portion 32a is a triangle.

FIG. 4C is another serial constructional view of metal line. The metal line 33 has a first portion 33a on one side and the first portion 33a is a recession. The first portion 33a and a second portion 33b connecting with the first portion 33a are differed in line width and the first portion 33a is a rectangle.

FIG. 4D is another serial constructional view of metal line. The metal line 34 has a first portion 34a on one side and the first portion 34a is a recession. The first portion 34a and a second portion 34b connecting with the first portion 34a are differed in line width and the first portion 34a is a polygon.

FIG. 4E is another serial constructional view of metal line. The metal line 35 has first portions 35a, 35b on both sides and the first portions 35a, 35b are recessions. The first portions 35a and 35b are a trapezoid. The first portions 35a, 35b and a second portion 35c are differed in line width.

FIG. 4F is the other serial constructional view of metal line. The metal line 36 has first portions 36a, 36b on both sides and the first portions 36a, 36b are recessions. The first portions 36a, 36b and a second portion 36c connecting with the first portions 36a, 36b are differed in line widths. The first portion 36a and 36b have different shape. The first portion 36a is an arc and the first portion 36b is a trapezoid.

In addition, the data lines in the embodiments of the invention also have similar structures of data line terminals, metal lines and short ring. One end of the data line terminal also connects to a short ring via a metal line. The difference is that another end of the data line terminal connects to the source of the thin film transistor.

In conclusion of present invention, the metal line having a first portion design on one-side or two-side of metal line provide position-recognition during the rim grinding process. The device largely reduces signal interference caused by connection bias to neighbouring line after IC-mounting, and prevents from line short-circuit problem.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A liquid crystal display (LCD) device, comprising:
a terminal;
an electrostatic discharge unit; and
a metal line electrically connected with said terminal and said electrostatic discharge unit, wherein said metal line extended along a first direction and said metal line comprising
a first portion; and
a second portion connecting with said first portion, wherein said first and second portions have different line widths.

2. The LCD device according to claim 1, wherein said terminal is a data line terminal.

3. The LCD device according to claim 1, wherein said terminal is a scanning line terminal.

4. The LCD device according to claim 1, wherein said electrostatic discharge unit comprises a short ring.

5. The LCD device according to claim 1, wherein said electrostatic discharge unit comprises a short bar.

6. The LCD device according to claim 1, wherein said first portion comprises a pattern of arc.

7. The LCD device according to claim 1, wherein said first portion comprises a pattern of triangle.

8. The LCD device according to claim 1, wherein said first portion comprises a pattern of polygon.

9. The LCD device according to claim 8, wherein said polygon comprises a pattern of rectangle.

10. The LCD device according to claim 8, wherein said polygon comprises a pattern of trapezoid.
